(19) United States
(12) Patent Application Publication
(10) Pub. No.: US 2026/0154616 A1
(43) Pub. Date: Jun. 4, 2026

(54) ON-DEVICE MONITORING AND ANALYSIS OF ON-DEVICE MACHINE LEARNING MODELS

(71) Applicant: Google LLC, Mountain View, CA (US)

(72) Inventors: Akash Agrawal, Mountain View, CA (US); Dragan Zivkovic, Mountain View, CA (US)

(73) Assignee: Google LLC, Mountain View, CA (US)

(21) Appl. No.: 19/123,376

(22) PCT Filed: Nov. 3, 2022
(86) PCT No.: PCT/US2022/079252

§ 371 Date: Apr. 22, 2025

(51) Int. Cl. G06N 20/00; G06F 11/34

(52) U.S. Cl. CPC G06N 20/00; G06F 11/3466

(57) ABSTRACT

A method (400) includes obtaining a pre-trained machine learning model (210T) from a remote system (150), receiving input data (221) captured by a user device (110), and processing, using an on-device machine learning model (210O) corresponding to the pre-trained machine learning model, the input data to generate a plurality of predicted outputs (222). The method also includes obtaining performance data (250) representing one or more performance characteristics of the on-device machine learning model, the one or more performance characteristics characterizing a performance of the on-device machine learning model related based on the plurality of predicted outputs, generating, using the performance data, one or more performance metrics (302) for the on-device machine learning model without exposing content of the input data or the plurality of the predicted outputs to the remote system, and transmitting the one or more performance metrics to the remote system.

### TECHNICAL FIELD

This disclosure relates to on-device machine learning (ML) models.

### BACKGROUND

Use of machine learning (ML) is increasingly common. These ML models may be configured and trained to generate any of variety of predictions, estimations, classifications, identifications, etc. based on input data. For example, to predict what a user spoke (i.e., a transcription) based on captured audio data representing spoken utterances of the user. In other examples, ML models are used to identify objects or persons in images, identify media content, and analyze medical images.

### SUMMARY

One aspect of the disclosure provides a method including obtaining a pre-trained machine learning model from a remote system, receiving input data captured by a user device, and processing, using an on-device machine learning model corresponding to the pre-trained machine learning model, to generate a plurality of predicted outputs. The method also includes obtaining performance data representing one or more performance characteristics of the on-device machine learning model, the one or more performance characteristics characterizing a performance of the on-device machine learning model based on the plurality of predicted outputs. The method further includes generating, using the performance data, one or more performance metrics for the on-device machine learning model without exposing content of the input data or the plurality of the predicted outputs to the remote system, and transmitting the one or more performance metrics to the remote system.

Implementations of the disclosure may include one or more of the following optional features. In some examples, the performance data includes differences between the plurality of predicted outputs and one or more user corrections to the plurality of predicted outputs. The differences may include a number of edits to the plurality of predicted outputs based on the one or more user corrections, and generating the one or more performance metrics includes determining, based on the number of edits, an edit rate. The differences may also include, for each particular predicted output of the plurality of predicted outputs, an indication of whether a user corrected the particular predicted output, and generating the one or more performance metrics includes determining, based on the indications, an occurrence rate of user corrections.

In some implementations, the performance data includes prediction likelihoods determined by the on-device machine learning model while generating the plurality of predicted outputs. In some examples, the performance data includes at least one of amounts of time to generate the plurality of predicted outputs, memory usages to generate the plurality of predicted outputs, or failures of a machine learning system executing the on-device machine learning model. In some implementations, obtaining the performance data includes obtaining the performance data for a plurality of time steps.

In some examples, the method also includes updating the on-device machine learning model over time based on the plurality of predicted outputs and one or more user corrections to the plurality of predicted outputs. The performance data may include prediction accuracies of the on-device machine learning model over time as the user device updates the the on-device machine learning model. The performance data may also include a quantity of parameter values of the on-device machine learning model changed over time. The prediction accuracies may include indications indicating that updating of the on-device machine learning model caused the on-device machine learning model to under learn a user correction or over learn a user correction.

In some implementations, the method further includes storing snap shots of the on-device machine learning model as the user device updates the on-device machine learning model, and reverting the on-device machine learning model to a stored snap shot based on one or more of the performance metrics. In some examples, obtaining the on-device machine learning model includes obtaining, for each particular performance metric of the one or more performance metrics, a particular metric definition including an indication of performance data related to the particular performance metric to obtain, and logic for generating the particular performance metric. The particular metric definition may also include logic for taking an action based on values of the particular performance metric. Additionally or alternatively, the logic for taking the action may include at least one of transmit the one or more performance metrics to the remote system, revert the on-device machine learning model to a previous state, disable the machine learning modes, discontinue updates to the on-device machine learning model, or replace the on-device machine learning model with a different on-device machine learning model. In some examples, the particular metric definition is generated by a developer that generated the pre-trained machine learning model, deployed, via the remote system, the pre-trained machine learning model to the user device and one or more other user devices, receives, via the remote system, the one or more performance metrics from the user device and the one or more other user devices, and analyzes the one or more performance metrics from the user device and the one or more other user devices to assess operation of the pre-trained machine learning model.

In some implementations, the method also includes storing the one or more performance metrics on the user device, and transmitting the one or more performance metrics to the remote system based on at least one of a periodic schedule, a received request, a value of a particular performance metric of the one or more performance metrics, or an error condition.

Another aspect of the disclosure provides a system including data processing hardware; and memory hardware in communication with the data processing hardware, the memory hardware storing instructions that when executed on the data processing hardware cause the data processing hardware to perform operations of a method including obtaining a pre-trained machine learning model from a remote system, receiving input data captured by a system, and processing, using an on-device machine learning model corresponding to the pre-trained machine learning model, to generate a plurality of predicted outputs. The method also includes obtaining performance data representing one or more performance characteristics of the on-device machine learning model, the one or more performance characteristics characterizing a performance of the on-device machine learning model based on the plurality of predicted outputs. The method further includes generating, using the performance data, one or more performance metrics for the on-device machine learning model without exposing content of the input data or the plurality of the predicted outputs to the remote system, and transmitting the one or more performance metrics to the remote system.

Implementations of the disclosure may include one or more of the following optional features. In some examples, the performance data includes differences between the plurality of predicted outputs and one or more user corrections to the plurality of predicted outputs. The differences may include a number of edits to the plurality of predicted outputs based on the one or more user corrections, and generating the one or more performance metrics includes determining, based on the number of edits, an edit rate. The differences may also include, for each particular predicted output of the plurality of predicted outputs, an indication of whether a user corrected the particular predicted output, and generating the one or more performance metrics includes determining, based on the indications, an occurrence rate of user corrections.

In some implementations, the performance data includes prediction likelihoods determined by the on-device machine learning model while generating the plurality of predicted outputs. In some examples, the performance data includes at least one of amounts of time to generate the plurality of predicted outputs, memory usages to generate the plurality of predicted outputs, or failures of a machine learning system executing the on-device machine learning model. In some implementations, obtaining the performance data includes obtaining the performance data for a plurality of time steps.

In some examples, the method also includes updating the on-device machine learning model over time based on the plurality of predicted outputs and one or more user corrections to the plurality of predicted outputs. The performance data may include prediction accuracies of the on-device machine learning model over time as the system updates the on-device machine learning model. The performance data may also include a quantity of parameter values of the on-device machine learning model changed over time. The prediction accuracies may include indications indicating that updating of the on-device machine learning model caused the on-device machine learning model to under learn a user correction or over learn a user correction.

In some implementations, the method further includes storing snap shots of the on-device machine learning model as the system updates the on-device machine learning model, and reverting the on-device machine learning model to a stored snap shot based on one or more of the performance metrics. In some examples, obtaining the on-device machine learning model includes obtaining, for each particular performance metric of the one or more performance metrics, a particular metric definition including an indication of performance data related to the particular performance metric to obtain, and logic for generating the particular performance metric. The particular metric definition may also include logic for taking an action based on values of the particular performance metric. Additionally or alternatively, the logic for taking the action may include at least one of transmit the one or more performance metrics to the remote system, revert the on-device machine learning model to a previous state, disable the machine learning modes, discontinue updates to the on-device machine learning model, or replace the on-device machine learning model with a different on-device machine learning model. In some examples, the particular metric definition is generated by a developer that generated the pre-trained machine learning model, deployed, via the remote system, the pre-trained machine learning model to the system and one or more other user devices, receives, via the remote system, the one or more performance metrics from the system and the one or more other user devices, and analyzes the one or more performance metrics from the system and the one or more other user devices to assess operation of the pre-trained machine learning model.

In some implementations, the method also includes storing the one or more performance metrics on the user device, and transmitting the one or more performance metrics to the remote system based on at least one of a periodic schedule, a received request, a value of a particular performance metric of the one or more performance metrics, or an error condition.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 depicts an example machine learning (ML) system that leverages on-device monitoring and analysis of on-device ML models.

FIG. 2 is a schematic view of an example of the on-device ML system of FIG. 1.

FIG. 3 is a schematic view of an example of the on-device ML monitoring process of FIG. 1.

FIG. 4 is a flowchart of an example arrangement of operations for a computer-implemented method for on-device monitoring and analysis of on-device ML models.

FIG. 5 is a schematic view of an example computing device that may be used to implement the systems and methods described herein.

Like reference symbols in the various drawings indicate like elements.

### DETAILED DESCRIPTION

Traditionally, performance monitoring and analysis for a machine learning (ML) model are performed on a central server using federated analytics, which aggregates data related to use of the ML model reported by an anonymous pool of distributed user or client devices (i.e., associated with end users). While the server may use the aggregated data to measure the impact of an ML feature (e.g., a new or updated ML model) for an entire group of user devices, the use of aggregated data fails to catch regression (e.g., degraded or worsening ML performance) in a small subset of the user devices. This may particularly be a problem when a user device is configured to personalize the user device's copy of the ML model based on local data captured by the user device. For example, a user device associated with a particular user may personalize a local copy of an automatic speech recognition (ASR) model to better recognize the particular user's spoken utterances. However, in some instances, ML model personalization by a user device may cause ML regression which, if not detected, may degrade a user's experience even though ML model personalization improves ML performance for a vast majority of user devices. A server using data aggregation may also be unable to detect when an ML feature was not be sufficiently trained (i.e., a model trained using training samples that are not sufficiently representative of the local data for a particular user device). For example, for a person who speaks English with a heavy foreign accent, an ASR model trained using only utterances spoken in English without any accent may perform poorly when attempting to recognize this person's utterances even though the ASR model works very well for a vast majority of users. Regression may be due to many reasons, such as under learning, over learning, bad system state, device capabilities, etc. When an ML feature works well for a vast majority of users, monitoring aggregate metrics fails to detect regression or poor performance on a small number of particular devices or for a small number of particular users. Moreover, even if ML regression on a few devices or for a few users could be detected from aggregated data, it may falsely lead a developer to turn off the ML feature or revert to a prior ML model, which may lead unnecessarily to worse ML performance for a vast majority of users. Furthermore, in some instances, regression may be due to aspects of a device (e.g., device state, processor capabilities, available memory, etc.) that are independent of an ML feature such that adjusting the ML feature for other users in response to such instances may be undesirable and lead unnecessarily to worse ML performance for a vast majority of users.

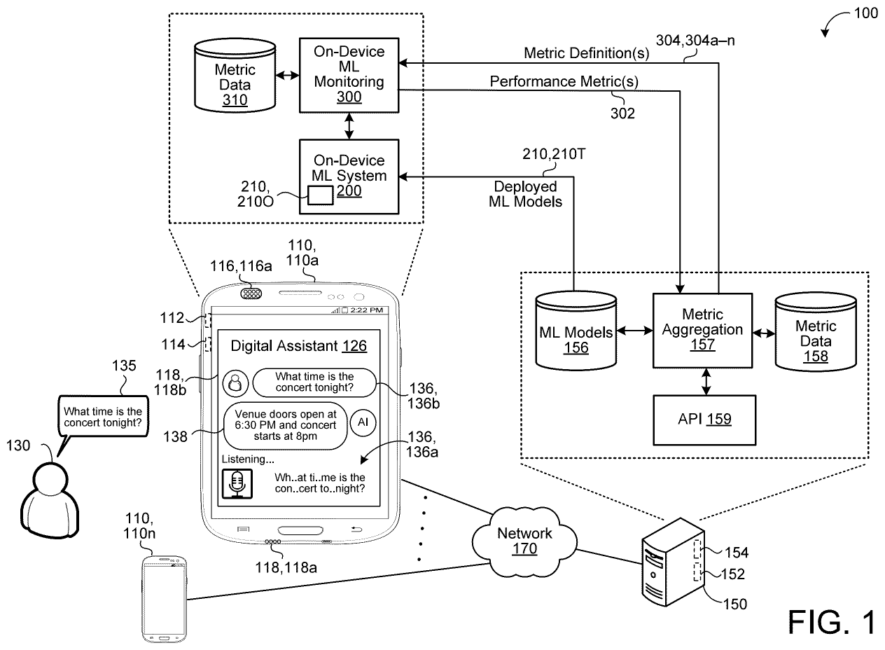

FIG. 1 is a schematic view of an example machine learning (ML) system 100 configured to leverage on-device monitoring and analysis of on-device ML models to assess and/or debug ML performance. In the example shown, the system 100 includes a remote system 150 and a plurality of client or user devices 110, 110a-n (generally referred to herein as user devices 110) each associated with a respective end user 130. The remote system 150 and the user devices 110 are communicatively coupled via one or more communication networks 170 (e.g., any combination of wired and/or wireless local area networks (LANs), wide area networks (WANs), cellular networks, and/or any other type(s) of network(s)).

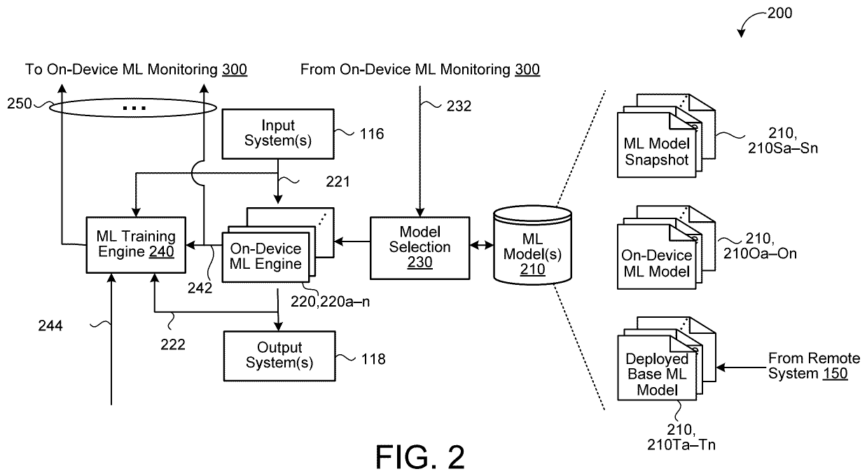

Each user device 110 includes an on-device ML system 200 and an on-device ML monitoring process 300. The on-device ML system 200 executes one or more on-device ML models 210, 210O configured to process, on the user device 110, input data 221 (FIG. 2) captured by the user device 110 to generate predicted outputs 222 (FIG. 2). Each on-device ML model 210O may include a corresponding one of one or more pre-trained ML models 210, 210T deployed to the user devices 110 by the remote system 150. In some examples, the on-device ML system 200 executes the pre-trained ML model 210T and updates or personalizes the pre-trained ML model 210T to generate a corresponding on-device ML models 210O that may differ from the initial version of the pre-trained ML model 210T that was deployed to the user device 110 by the remote system 150. That is, and a result of on-device personalization and updates to an initial pre-trained ML model 210T deployed to multiple user devices 110, one on-device ML model 210O corresponding to a first user device's on-device copy of the deployed ML model 210T may be different from another on-device ML model 210O corresponding to a second user device's on-device copy of the same deployed ML model 210T. In some examples, the on-device ML system 200 saves snap shots of personalized on-device ML models 210O over time as the personalized on-device ML models 210O are trained, updated, or otherwise personalized.

The on-device ML monitoring process 300 is configured to monitor and analyze the ML performance of one or more on-device ML models 210O implemented by the on-device ML system 200. In particular, the on-device ML monitoring process 300 obtains performance data 250 (FIG. 2) representing one or more performance characteristics of one or more on-device ML models 210O (e.g., from the on-device ML system 200), computes one or more user device-specific ML model performance metrics 302 (i.e., on-device ML performance metrics 302) based on the performance data, and analyzes the on-device ML performance metrics 302 to identify ML performance trends over time. The on-device ML monitoring process 300 may aggregate, on the user device 110, the on-device computed ML performance metrics 302 over time to populate a database (e.g., stored securely in a datastore 310 of the user device 110) that tracks how well particular ML features (e.g., ML models) are performing on the user device 110. Example performance data 250 includes, but is not limited to, for or over a plurality of time steps, differences between predicted outputs of on-device ML models and user corrections thereto; a number of edits (e.g., word additions, word deletions, word replacements made to transcriptions of spoken utterances); indications of whether and/or which predicted outputs are corrected; prediction likelihoods associated with prediction hypotheses determined by an on-device ML model while generating predicted outputs; processing time to generate predicted outputs; memory usage to generate predicted outputs; fault conditions; machine learning system failure conditions; prediction accuracies; a quantity of parameter values of a ML model that changed over time; user indications for whether a correction was over or under learned (e.g., a user keeps making the same correction or reverts a previously trained correction); and user feedback. Example ML model performance metrics 302 include, but are not limited to, an edit rate (e.g., how often and how many edits are made to transcriptions of spoken utterances over time, such as a word error rate (WER)); an occurrence rate of user corrections; whether prediction confidence is increasing or decreasing; whether parameter values of an ML model are dithering; a processor usage trend; and a memory usage trend.

In some examples, the on-device ML monitoring process 300 is configured to take one or more actions responsive to on-device ML performance metrics 302, or trends based on the non-device ML performance metrics 302. That is, the on-device ML monitoring process 300 may, in response to local on-device ML performance metrics 302, locally adjust operations performed by the on-device ML system 200 or the on-device ML models implemented by the on-device ML system 200 (i.e., measure local and act local). In some implementations, the on-device ML monitoring process 300 uses on-device ML model performance trends over time to determine whether to turn on-device ML functionality on or off, to disable ML functionality, to reset the state of an on-device ML model 210O, to revert to a prior on-device ML model snapshot 210, 210S (FIG. 2) (e.g., to revert to a best performing prior version of an on-device ML model), to discontinue updates of an on-device ML model 210O, to replace an on-device ML model 210O with a different ML model, etc. For example, in the case of on-device personalization of an on-device ML model 210O corresponding to an ASR model, the on-device ML monitoring process 300 analyzes and tracks the speech recognition performance of the on-device personalized ASR model (e.g., measured by how many transcription corrections a user makes) over a period of time, i.e., to determine a WER of the ASR model. Thus, when the on-device ML monitoring process 300 detects performance regression for the ASR model (e.g., worsening speech recognition accuracy correlated by an increasing WER), the on-device ML monitoring process 300 may disable future personalizations, revert to a previously trained ASR model, revert to a base ASR model (e.g., a non-personalized model), file a bug report, etc. The on-device ML monitoring process 300 may also be responsive to user inputs. For example, a user provides an indication that any on-device ML model updates made in the past N days should be discarded because any user corrections provided during those days were provided by a party other than the user 130 associated with a user device 110 (e.g., a child got hold of a parent's user device 110).

The on-device ML monitoring process 300 may also provide on-device ML monitoring and analysis results (e.g., the on-device ML performance metrics 302) to the remote system 150 in, for example, periodic reports, responses to queries, debug logs, or bug reports that may be used by ML developers to identify and debug ML model issues that affect even just a small subset of the user devices 110. In some examples, the on-device ML monitoring process 300 computes the on-device ML performance metrics 302 such that the on-device ML performance metrics 302 do not contain or reveal any content of captured input data or predicted outputs (i.e., anonymizes and/or sanitizes the performance metrics 302).

In some implementations, the ML developer of a deployed ML model obtaining a pre-trained machine learning model from a remote system, receiving input data captured by a user device, and processing, using an on-device machine learning model corresponding to the pre-trained machine learning model, to generate a plurality of predicted outputs. The method also includes obtaining performance data representing one or more performance characteristics of the on-device machine learning model, the one or more performance characteristics characterizing a performance of the on-device machine learning model based on the plurality of predicted outputs. The method further includes generating, using the performance data, one or more performance metrics for the on-device machine learning model without exposing content of the input data or the plurality of the predicted outputs to the remote system, and transmitting the one or more performance metrics to the remote system.

Implementations of the disclosure may include one or more of the following optional features. In some examples, the performance data includes differences between the plurality of predicted outputs and one or more user corrections to the plurality of predicted outputs. The differences may include a number of edits to the plurality of predicted outputs based on the one or more user corrections, and generating the one or more performance metrics includes determining, based on the number of edits, an edit rate. The differences may also include, for each particular predicted output of the plurality of predicted outputs, an indication of whether the user corrected the particular predicted output, and generating the one or more performance metrics includes determining, based on the indications, an occurrence rate of user corrections.

In some implementations, the performance data includes prediction likelihoods determined by the on-device machine learning model while generating the plurality of predicted outputs. In some examples, the performance data includes at least one of amounts of time to generate the plurality of predicted outputs, memory usages to generate the plurality of predicted outputs, or failures of a machine learning system executing the on-device machine learning model. In some implementations, obtaining the performance data includes obtaining the performance data for a plurality of time steps.

In some examples, the method also includes updating the on-device machine learning model over time based on the plurality of predicted outputs and one or more user corrections to the plurality of predicted outputs. The performance data may include prediction accuracies of the on-device machine learning model over time as the user device updates the the on-device machine learning model. The performance data may also include a quantity of parameter values of the on-device machine learning model changed over time. The prediction accuracies may include indications indicating that updating of the on-device machine learning model caused the on-device machine learning model to under learn a user correction or over learn a user correction.

In some implementations, the method further includes storing snap shots of the on-device machine learning model as the user device updates the on-device machine learning model, and reverting the on-device machine learning model to a stored snap shot based on one or more of the performance metrics. In some examples, obtaining the on-device machine learning model includes obtaining, for each particular performance metric of the one or more performance metrics, a particular metric definition including an indication of performance data related to the particular performance metric to obtain, and logic for generating the particular performance metric. The particular metric definition may also include logic for taking an action based on values of the particular performance metric. Additionally or alternatively, the logic for taking the action may include at least one of transmit the one or more performance metrics to the remote system, revert the on-device machine learning model to a previous state, disable the machine learning modes, discontinue updates to the on-device machine learning model, or replace the on-device machine learning model with a different on-device machine learning model. In some examples, the particular metric definition is generated by a developer that generated the pre-trained machine learning model, deployed, via the remote system, the pre-trained machine learning model to the user device and one or more other user devices, receives, via the remote system, the one or more performance metrics from the user device and the one or more other user devices, and analyzes the one or more performance metrics from the user device and the one or more other user devices to assess operation of the pre-trained machine learning model.

In some implementations, the method also includes storing the one or more performance metrics on the user device, and transmitting the one or more performance metrics to the remote system based on at least one of a periodic schedule, a received request, a value of a particular performance metric of the one or more performance metrics, or an error condition. provides, together with the deployed ML model 210T, one or metric definitions 304 that define, for the on-device ML monitoring process 300, how and what on-device ML performance metrics 302 are to be computed, tracked and reported, and automated actions to take responsive to on-device ML performance metrics 302, or trends of the on-device ML performance metrics 302. That is, an ML developer can define a priori preemption, reversion, or escape mechanisms in case a deployed ML model 210O does not perform on a particular user device 110 in way that the ML developer intended (e.g., fails to satisfy one or more performance thresholds). In this way, the ML developer can configure the on-device ML monitoring process 300 of the user devices 110 to reduce the likelihood that a deployed ML feature (e.g., an ML model 210T) negatively impacts even a small subset of user devices 110 and obtain on-device ML performance metric 302 that enable the ML developer to identify the root cause(s) of an ML performance issue even when the issue only effects a small subset of the user devices 110. In some implementations, the on-device ML monitoring process 300, responsive to a metric definition 304, instruments or configures the on-device ML system 200 to capture the performance data needed for computing particular ML performance metrics 302 and to store the captured performance data on the user device (e.g., securely in the datastore 310). In some examples, the on-device ML monitoring process 300 processes the captured performance data to compute the on-device ML performance metrics 302 when, for example, the user device 110 is idle (e.g., a user is not currently interacting with the user device 110 or current resource utilization of the user device 110 satisfies a threshold) to avoid interfering with other functions of the user device 110.

As used herein, on-device refers to a particular user device 110 executing/performing a process or function on behalf of an end user 130 of the user device 110 entirely independent of computing and storage resources implemented on a remote system 150 or any other user device 110. For example, an on-device ML model 210O refers to an ML model that is implemented by or on a user device 110. This is in contrast to the sending of input data captured by a user device 110 to a central server (e.g., the remote system 150), which executes an ML model on behalf of the user device 110 and one or more other user devices 110, computes predicted outputs for the input data using the ML model, and returns the predicted outputs to the user device 110. Similarly, on-device monitoring and analysis of an on-device ML model 210O refers to monitoring and analysis of an on-device ML model 210O that is performed locally by or on a user device 110. That is, the user device 110 performs the monitoring and analysis of the on-device ML model 210O without sending any performance related data collected by the user device 110 to the remote system 150. In some implementations, data processing hardware 112 (e.g., a programmable processor) of a user device 110 executes instructions stored on memory hardware 114 of the user device 110 to implement the on-device ML system 200 and the on-device ML monitoring process 300. Additionally or alternatively, the data processing hardware 112 may implement special purpose data hardware (e.g., a tensor processing unit (TPU)) for execution of the on-device ML models 210O on the user device 110.

The user devices 110 may correspond to any personal computing devices associated with users and capable of receiving inputs, processing, and providing outputs. Some examples of user devices 110 include, but are not limited to, mobile devices (e.g., mobile phones, tablets, laptops, etc.), computers, wearable devices (e.g., smart watches), smart appliances, internet of things (IoT) devices, vehicle infotainment systems, smart displays, smart speakers, etc. Each user device 110 includes data processing hardware 112, and memory hardware 114 in communication with the data processing hardware 112. The memory hardware 114 stores instructions that, when executed by the data processing hardware 112, cause the data processing hardware 112 or, more generally, the user device 110, to perform one or more operations. Each user device 110 includes, or may be coupled to, one or more input systems 116 (e.g., an audio capture device such as a microphone 116a, a virtual keyword, a keyboard, etc.) to capture, record, receive, or otherwise obtain, user inputs (e.g., spoken utterances) for the user device 110. Each user device 110 also includes, or may be coupled to, one or more output systems 118 (e.g., a speaker 118a, a screen 118b, etc.) to output or otherwise provide outputs of the user device 110 (e.g., predicted outputs of an on-device ASR model) to a user 130. The input system(s) 116 may also be used to obtain user inputs from other users 130, devices, systems, etc. The output system(s) 118 may also be used to provide outputs to other users 130, devices, systems, etc.

In an example, the on-device ML system 200 of an example user device 110a implements an on-device ML model 210O that includes an ASR model (not shown for clarity of illustration). The ASR model may include a recurrent neural network-transducer (RNN-T) model and an optional rescorer that each reside on the user device 110a. The input system(s) 116 of the example user device 110a include an audio subsystem configured to receive an utterance 135 spoken by a user 130a and captured by the audio capture device 116a (e.g., one or more microphones), and convert the captured utterance 135 into a corresponding digital format associated with input audio data capable of being digitally input to and processed by the ASR system. Thereafter, the RNN-T model receives, as input, the audio data corresponding to the utterance 135, and generates/predicts, as output, a corresponding transcription 136 (e.g., recognition result/hypothesis) of the utterance 135. The RNN-T model may perform streaming speech recognition to produce an initial speech recognition result 136, 136a and the rescorer may update (i.e., rescore) the initial speech recognition result 136a to produce a final speech recognition result 136, 136b. Thereafter, when, for example, natural language processing (NLP) performed on the final speech recognition result 136b recognizes that the spoken utterance 135 is, for example, a command or query, the user device 110a may provide the final speech recognition result 136b to a downstream application (e.g., a digital assistant 126) to perform the command or identify a response to the query (e.g., a response 138).

In another example, the on-device ML system 200 of an example user device 110 implements a text-to-speech (TTS) model 210O configured to convert input text into synthesized speech representation which may be used by a vocoder/synthesizer (not shown for clarity of illustration) to audibly output synthesized speech corresponding to the input text. The input system(s) 116 of the example user device 110 include a text input subsystem (e.g., a keyboard, or a virtual keyboard) configured to receive input text from a user 130 (i.e., input data representing one or more characters and/or words). Alternatively, the input text is received from a digital assistant 126 with which the user 130 is interacting. For example, the user 130 types input text and the digital assistant 126 responds with synthesized speech outputs. In some examples, the on-device ML system 200 additionally implements an ASR model, such as the ASR described above, such that the user 130b interacts with the digital assistant 126 via spoken utterance inputs and synthesized speech outputs.

The on-device ML system 200 may similarly implement any number and variety of other on-device ML models 210O. For example, the on-device ML system 200 implements, without limit, an image recognition ML model, a classification ML model, a medical diagnostic ML model, an object identification ML model, a person identification ML model, a speaker identification ML model, a media content identification ML model, a speech-to-speech model, a language model, a language translation model, a machine translation model, or any other type of ML model that is trained via ML to generate predicted outputs based on received inputs.

Referring to FIG. 1, the remote system 150 includes data processing hardware 152, and memory hardware 154 in communication with the data processing hardware 152. The memory hardware 154 stores instructions that, when executed by the data processing hardware 152, cause the data processing hardware 152 to perform one or more operations, such as those disclosed herein. In some examples, the remote system 150 is provided by an ML model developer. Alternatively, the remote system 150 is a central server that trains and deploys ML models 210T and metric definitions 304, and obtains on-device ML performance metrics 302 from user devices 110 executing the deployed ML models 210T on behalf of a plurality of different ML model developers.

The example remote system 150 includes an ML model datastore 156 for storing the ML models 210T deployed by the remote system 150 to the user devices 110. In some examples, metric definitions 304 are stored together with their respective ML models 210T in the ML model datastore 156.

In the example shown, the remote system 150 includes a metric aggregation process 157 for receiving or obtaining on-device ML performance metrics 302 from the user devices 110, and storing the on-device ML performance metrics 302 in a metric data datastore 158. In some implementations, the metric aggregation process 157 populates a database stored on the datastore 158 to track how well particular ML features are performing on various user devices 110 over time. In some examples, the metric aggregation process 157 aggregates the on-device ML performance metrics 302 received from various user devices 110 to determine the performance of an ML feature for a population of user devices 110 as a whole. Additionally or alternatively, the metric aggregation process 157 uses the on-device ML performance metrics 302 for a particular user device 110 to track the performance of a particular ML feature on that particular user device 110. In some examples, when ML performance metrics 302 are degraded for a particular user device 110, the metric aggregation process 157 receives the on-device ML performance metrics 302 from the particular user device 110 via a debug log or bug report such that the metric aggregation process 157 is aware that an on-device ML model implemented by the particular user device 110 is not be performing as expected by the ML developer for the ML model.

The remote system 150 includes an application programming interface (API) 159 or other user interface for enabling an ML model developer to provide an ML model 210T that is to be deployed by the remote system 150 to the user devices 110 along with one or more corresponding metric definitions 304 for the ML model 210T that will also be provided to the user devices 110. In some examples, the remote system 150 stores a database of metric definitions 304 such that an ML model developer can simply select which metric definitions 304 in the database are to be used with a particular deployed ML model 210T. Additionally or alternatively, the user devices 110 store a database of metric definitions 304 such that an ML model developer can simply identify for the user devices 110 which on-device ML performance metrics 304, or trends thereof, are to the computed and tracked.

FIG. 2 is a schematic view of an example of the on-device ML system 200 of FIG. 1. The on-device ML system 200 includes an ML model datastore 210 for storing one or more deployed ML models 210, 210Ta-Tn received from the remote system 150, one or more on-device ML models 210, 210Oa-On, and/or one or more ML model snapshots 210, 210Sa-Sn (i.e., snapshots of on-device ML models 210O). The on-device ML models 210O may include personalized on-device ML models, that is, personalized copies or versions of the deployed ML models 210T.

The on-device ML system 200 includes one or more on-device ML engines 220, 220a-n configured to execute on-device ML models 210O for processing input data 221 captured by the input system(s) 116 to generate predicted outputs 222, which can, for example, be output by the output system(s) 118 or provided for use by the user device 110 or digital assistant 126 in performing downstream operations. In some implementations, the data processing hardware 112 (e.g., a programmable processor) of the user device 110 executes instructions stored on the memory hardware 114 of the user device 110 to implement one or more of the on-device ML engines 220 to execute on-device ML models 210O. In some examples, that data processing hardware 112 includes special purpose data hardware (e.g., a tensor processing unit (TPU)) to implement the on-device ML engines 220 for executing the on-device ML models 210O. In some examples, an on-device ML engine 220 executes more than one on-device ML model 210O.

The on-device ML system 200 includes a model selection process 230 for selecting, responsive to inputs 232 received from the on-device ML monitoring process 300, on-device ML models for execution by the on-device ML engines 220. For example, the on-device ML monitoring process 300 selects a current version of an on-device ML model 210O or a previous snapshot 210S of the on-device ML model 210O for execution by an on-device ML engine 220. The on-device ML monitoring process 300 may also control the model selection process 230 to disable an on-device ML model 210O or snapshot 210S such that the on-device ML engines 220 no longer execute the disabled on-device ML model 210O or snapshot 210S.

In some examples, the on-device ML system 200 includes an on-device ML training engine 240 for personalizing or updating on-device ML models 210O based on, for example, captured input data 221, predicted outputs 222, prediction related data 242 from the on-device ML engines 220 (e.g., prediction hypotheses, prediction likelihoods, etc.), and/or user inputs 244 (e.g., user corrections).

In the example shown, the on-device ML system 200 is instrumented (e.g., configured) to capture and provide, to the on-device ML monitoring process 300, ML performance data 250 representing one or more performance characteristics of one or more on-device ML models 210O executing on the user device 110. In some implementations, the on-device ML monitoring process 300 configures, for each on-device ML model 210, what performance data 250 the on-device ML system 200 is to capture and report to the on-device ML monitoring system 300. In some additional implementations, a deployed ML model 210T includes a definition of what performance data 250 is to be captured. In other implementations, the on-device ML system 200 is configured to collect and provide a default or standardized set of performance data 250 for each executed on-device ML model 210O to the on-device ML monitoring process 300, and the on-device ML monitoring process 300 determines which performance data 250 to store and use to compute the ML performance metrics 302.

Example performance data includes, without limitation, for or over a plurality of time steps, differences between predicted outputs of on-device ML models and user corrections thereto; a number of edits (e.g., word additions, word deletions, word replacements made to transcriptions of spoken utterances); indications of whether and/or which predicted outputs are corrected; prediction likelihoods associated with prediction hypotheses determined by an on-device ML model while generating predicted outputs; processing time to generate predicted outputs; memory usage to generate predicted outputs; fault conditions; machine learning system failure conditions; prediction accuracies; a quantity of parameter values of a ML model that changed over time; user indications for whether a correction was over or under learned (e.g., a user keeps making the same correction, or reverts a previously trained correction); and user feedback.

While an example on-device ML system 200 is illustrated in FIG. 2, one or more of the elements and processes illustrated in FIG. 2 may be combined, divided, re-arranged, omitted, eliminated, or implemented in any other way. Further, an on-device ML system 200 may include one or more elements or processes in addition to, or instead of, those illustrated in FIG. 2, or may include more than one of any or all of the illustrated elements and processes.

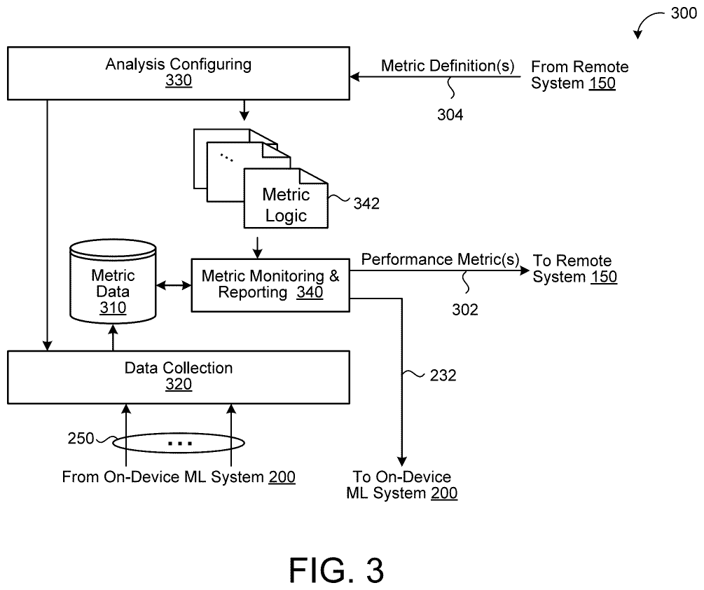

FIG. 3 is a schematic of an example of the on-device ML monitoring process 300. The on-device ML monitoring process 300 includes a data collection process 320 for obtaining or receiving over time, and for a plurality of time steps, ML performance data 250 from the on-device ML system 200 and storing the ML performance data 250 in the metric datastore 310. The datastore 310 may store or retain the performance data 250 for any period of time. For example, for the duration of a reporting period, a duration defined by an ML model developer, until the datastore 310 is full and older performance data 250 is discarded, until a user device 110 is restarted, etc. In some implementations, the data collection process 320 configures the on-device ML system 200 to provide particular performance data 250 for particular on-device ML models 210O. In some additional implementations, the performance data 250 includes a default or standardized set of performance data 250, and the data collection process 320 selects which data of the performance data 250 is stored in the datastore 310.

The on-device monitoring process 300 includes an analysis configuring process 330 to, responsive to metric definitions 304, configure the data collection process 320 and/or the on-device ML system 200 to collect particular ML performance data 250, and store the performance data 250 in the datastore 310. The analysis configuring process 330 also configures, responsive to metric definitions 304, one or more sets of metric logic 342 for computing and reporting the ML performance metrics 302, and/or trends thereof. The sets of metric logic 342 may also set forth actions to be taken responsive to ML performance metrics 302, and/or trends thereof.

The on-device monitoring process 300 includes a metric monitoring and reporting process 340 for executing the sets of metric logic 342 to compute and track ML performance metrics 302, and/or trends thereof, and/or take actions responsive to ML performance metrics 302, and/or trends thereof.

For example, one of the sets of metric logic 342 may define how the metric monitoring and reporting process 340 is to compute one or more particular ML performance metrics 302. In particular, the metric logic 342 may define what performance data 250 the metric monitoring and reporting process 340 is to use, what logic or equations the metric monitoring and reporting process 340 is to use to process the performance data 250 to compute the particular ML performance metrics 302, and/or how the metric monitoring and reporting process 340 is to aggregate the particular ML performance metrics 302 over time to identify and track trends of the ML performance metrics 302. Example ML model performance metrics 302 include, without limit, an edit rate (e.g., how often and how many edits are made to transcriptions of spoken utterances over time, such as a word error rate (WER)); an occurrence rate of user corrections; whether prediction confidence is increasing or decreasing; whether parameter values of an ML model are dithering; a processor usage trend; and a memory usage trend. For example, in the case of on-device personalization of an on-device ASR model, one of the sets of metric logic 342 may cause the metric monitoring and reporting process 340 to analyze and track the speech recognition performance of the on-device personalized ASR model (e.g., measured by how many transcription corrections a user makes) over a period of time. In some examples, the metric monitoring and reporting process 340 computes the on-device ML performance metrics 302 such that the on-device ML performance metrics 302 do not contain or reveal any content of captured input data or predicted outputs (e.g., to the remote system 150).

One of the sets of metric logic 342 may, additionally or alternatively, define when and/or how the metric monitoring and reporting process 340 is store, log and/or report the particular ML performance metrics 302. For example, the set of metric logic 342 defines that the ML performance metrics 302 are to be provided via periodic reports, responses to queries, debug logs, and/or bug reports.

One of the sets of metric logic 342 may, additionally or alternatively, define one or more particular actions the metric monitoring and reporting process 340 is take, and the logic used by the metric monitoring and reporting process 340 to determine when the particular actions are to be taken. Example particular actions include, but are not limited to, turning on-device ML functionality on or off, disabling ML functionality, resetting the state of an on-device ML model, reverting an on-device ML model to a prior on-device ML model snap shot (e.g., to revert to a best performing prior version of an on-device ML model), discontinuing updates of an on-device ML model, and replacing an on-device ML model with a different ML model. For example, when the metric monitoring and reporting process 340 detects performance regression for an ASR model (e.g., worsening speech recognition accuracy), a set of metric logic 342 causes the metric monitoring and reporting process 340 to disable future personalizations, revert to a previously trained ASR model, revert to a base ASR model (non-personalized model), file a bug report, etc.

One of the sets of metric logic 342 may, additionally and/or alternatively, define how the metric monitoring and reporting process 340 is to respond to user inputs. For example, a user may provide an indication that any on-device ML model updates made in the past N days should be discarded because any user corrections provided during those days were provided by a person other than the user 130 associated with a user device 110 (e.g., a child got hold of a parent's user device 110), such that the set of metric logic 342 causes the metric monitoring and reporting process 340 to revert the on-device ML model to a prior version.

While an example on-device ML monitoring process 300 is illustrated in FIG. 3, one or more of the elements and processes illustrated in FIG. 3 may be combined, divided, re-arranged, omitted, eliminated, or implemented in any other way. Further, an on-device ML monitoring process 300 may include one or more elements or processes in addition to, or instead of, those illustrated in FIG. 3, or may include more than one of any or all of the illustrated elements and processes.

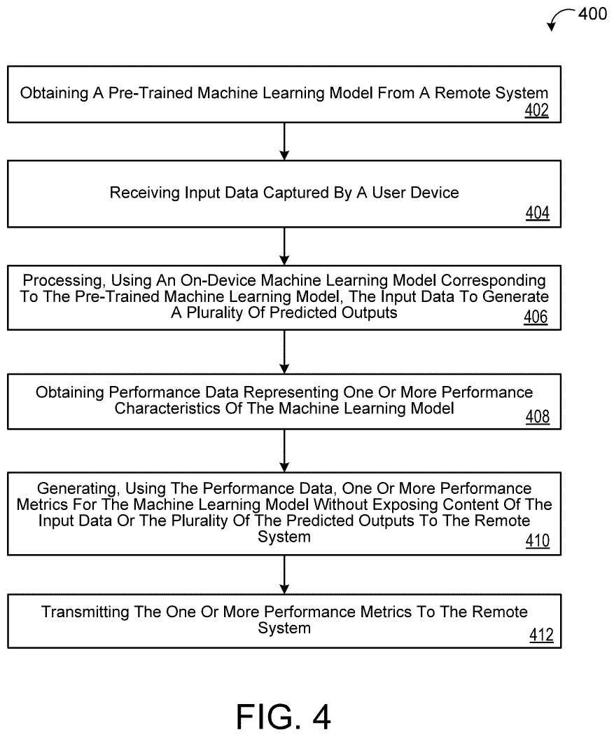

FIG. 4 is a flowchart of an exemplary arrangement of operations for a computer-implemented method 400 executed by a user device 110 for on-device monitoring and analysis of on-device ML models 210O. At operation 402, the method 400 includes obtaining a pre-trained machine learning model 210T from a remote system 150. At operation 404, the method 400 includes receiving input data 221 captured by the user device 110. The method 400 includes, at operation 406, processing, using an on-device ML model 210O corresponding to the pre-trained ML model 210T, to generate a plurality of predicted outputs 222.

At operation 408, the method 400 includes obtaining performance data 250 representing one or more performance characteristics of the on-device ML model 210O, the one or more performance characteristics characterizing a performance of the on-device ML model 210O based on the plurality of predicted outputs 222. At operation 410, the method 400 includes generating, using the performance data 250, one or more performance metrics 302 for the on-device ML model 210O without exposing content of the input data 221 or the plurality of the predicted outputs 222 to the remote system 150. The method 400 includes, at operation 412, transmitting the one or more performance metrics 302 to the remote system 150.

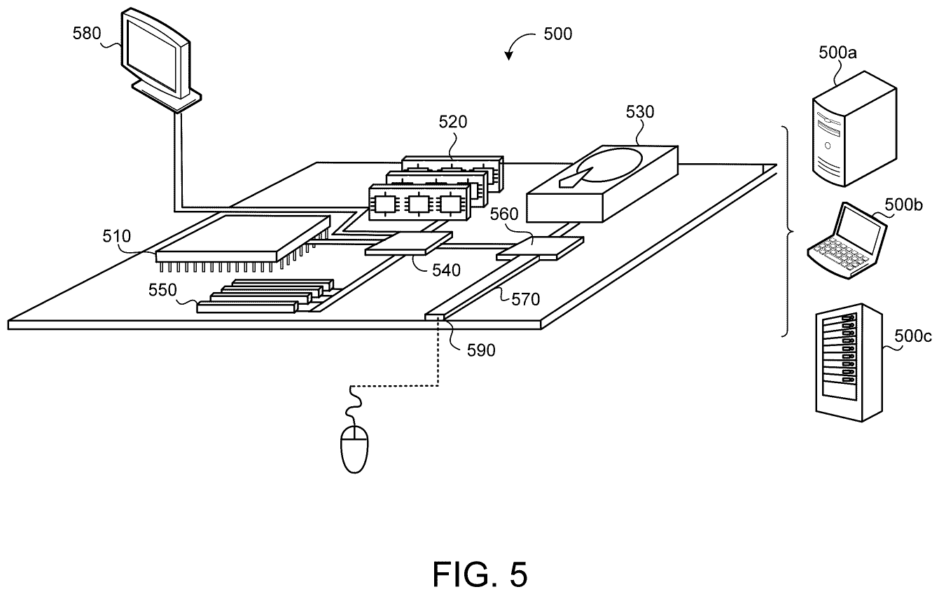

FIG. 5 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510 (i.e., data processing hardware) that can be used to implement the data processing hardware 112 and/or 152, memory 520 (i.e., memory hardware) that can be used to implement the memory hardware 114 and/or 154, a storage device 530 (i.e., memory hardware) that can be used to implement the memory hardware 114 and/or 154, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C.

A number of implementations have been described. Nevertheless, it will be understood that various modifications may be made without departing from the spirit and scope of the disclosure. Accordingly, other implementations are within the scope of the following claims.

1. A computer-implemented method when executed on data processing hardware of a user device causes the data processing hardware to perform operations comprising:
obtaining a pre-trained machine learning model from a remote system;
receiving input data captured by the user device;
processing, using an on-device machine learning model corresponding to the pre-trained machine learning model, the input data to generate a plurality of predicted outputs;
obtaining performance data representing one or more performance characteristics of the on-device machine learning model, the one or more performance characteristics characterizing a performance of the on-device machine learning model based on the plurality of predicted outputs;
generating, using the performance data, one or more performance metrics for the on-device machine learning model without exposing content of the input data or the plurality of the predicted outputs to the remote system; and
transmitting the one or more performance metrics to the remote system.

2. The computer-implemented method of claim 1, wherein the performance data comprises differences between the plurality of predicted outputs and one or more user corrections to the plurality of predicted outputs.

3. The computer-implemented method of claim 2, wherein:
the differences comprise a number of edits to the plurality of predicted outputs based on the one or more user corrections; and
generating the one or more performance metrics comprises determining, based on the number of edits, an edit rate.

4. The computer-implemented method of claim 2, wherein:
the differences comprise, for each particular predicted output of the plurality of predicted outputs, an indication of whether a user corrected the particular predicted output; and
generating the one or more performance metrics comprises determining, based on the indications, an occurrence rate of user corrections.

5. The computer-implemented method of claim 1, wherein the performance data comprises prediction likelihoods determined by the on-device machine learning model while generating the plurality of predicted outputs.

6. The computer-implemented method of claim 1, wherein the performance data comprises at least one of:
amounts of time to generate the plurality of predicted outputs;
memory usages to generate the plurality of predicted outputs; or
failures of a machine learning system executing the on-device machine learning model.

7. The computer-implemented method of claim 1, wherein obtaining the performance data comprises obtaining the performance data for a plurality of time steps.

8. The computer-implemented method of claim 1, wherein:
the operations further comprise updating the on-device machine learning model over time based on the plurality of predicted outputs and one or more user corrections to the plurality of predicted outputs; and
the performance data comprises prediction accuracies of the on-device machine learning model over time as the user device updates the on-device machine learning model.

9. The computer-implemented method of claim 8, wherein the performance data further comprises a quantity of parameter values of the on-device machine learning model changed over time.

10. The computer-implemented method of claim 8, wherein the prediction accuracies comprise indications indicating that updating of the on-device machine learning model caused the on-device machine learning model to under learn a user correction or over learn a user correction.

11. The computer-implemented method of claim, wherein the operations further comprise:
storing snap shots of the on-device machine learning model as the user device updates the on-device machine learning model; and
reverting the on-device machine learning model to a stored snap shot based on one or more of the performance metrics.

12. The computer-implemented method of claim 1, wherein obtaining the on-device machine learning model comprises obtaining, for each particular performance metric of the one or more performance metrics, a particular metric definition comprising:
an indication of performance data related to the particular performance metric to obtain; and
logic for generating the particular performance metric.

13. The computer-implemented method of claim 12, wherein the particular metric definition further comprises logic for taking an action based on values of the particular performance metric.

14. The computer-implemented method of claim 13, wherein the logic for taking the action causes the data processing hardware to at least one of:
transmit the particular performance metric to the remote system;
revert the on-device machine learning model to a previous state;
disable the on-device machine learning model;
discontinue updates to the on-device machine learning model; or
replace the on-device machine learning model with a different on-device machine learning model.

15. The computer-implemented method of claim 12, wherein the particular metric definition is generated by a developer that:
generated the pre-trained machine learning model;
deployed, via the remote system, the pre-trained machine learning model to the user device and one or more other user devices;
receives, via the remote system, the one or more performance metrics from the user device and the one or more other user devices; and
analyzes the one or more performance metrics from the user device and the one or more other user devices to assess operation of the pre-trained machine learning model.

16. The computer-implemented method of claim 1, wherein the operations further comprise:
storing the one or more performance metrics on the user device; and
transmitting the one or more performance metrics to the remote system based on at least one of a periodic schedule, a received request, a value of a particular performance metric of the one or more performance metrics, or an error condition.

17. A system comprising:
data processing hardware; and
memory hardware in communication with the data processing hardware, the memory hardware storing instructions that when executed on the data processing hardware cause the data processing hardware to perform operations comprising:
obtaining a pre-trained machine learning model from a remote system;
receiving input data captured by the system;
processing, using an on-device machine learning model corresponding to the pre-trained machine learning model, the input data to generate a plurality of predicted outputs;
obtaining performance data representing one or more performance characteristics of the on-device machine learning model, the one or more performance characteristics characterizing a performance of the on-device machine learning model based on the plurality of predicted outputs;
generating, using the performance data, one or more performance metrics for the on-device machine learning model without exposing content of the input data or the plurality of the predicted outputs to the remote system; and
transmitting the one or more performance metrics to the remote system.

18. The system of claim 17, wherein the performance data comprises differences between the plurality of predicted outputs and one or more user corrections to the plurality of predicted outputs.

19. The system of claim 18, wherein:
the differences comprise a number of edits to the plurality of predicted outputs based on the one or more user corrections; and
generating the one or more performance metrics comprises determining, based on the number of edits, an edit rate.

20. The system of claim 18, wherein:
the differences comprise, for each particular predicted output of the plurality of predicted outputs, an indication of whether a user corrected the particular predicted output; and
generating the one or more performance metrics comprises determining, based on the indications, an occurrence rate of user corrections.

21. The system of claim 17, wherein the performance data comprises prediction likelihoods determined by the on-device machine learning model while generating the plurality of predicted outputs.

22. The system of claim 17, wherein the performance data comprises at least one of:
amounts of time to generate the plurality of predicted outputs;
memory usages to generate the plurality of predicted outputs; or
failures of a machine learning system executing the on-device machine learning model.

23. The system of claim 17, wherein obtaining the performance data comprises obtaining the performance data for a plurality of time steps.

24. The system of claim 17, wherein:
the operations further comprise updating the on-device machine learning model over time based on the plurality of predicted outputs and one or more user corrections to the plurality of predicted outputs; and
the performance data comprises prediction accuracies of the on-device machine learning model over time as the system updates the on-device machine learning model.

25. The system of claim 24, wherein the performance data further comprises a quantity of parameter values of the on-device machine learning model changed over time.

26. The system of claim 24, wherein the prediction accuracies comprise indications indicating that updating of the on-device machine learning model caused the on-device machine learning model to under learn a user correction or over learn a user correction.

27. The system of claim 17, wherein the operations further comprise:
storing snap shots of the on-device machine learning model as the system updates the on-device machine learning model; and
reverting the on-device machine learning model to a stored snap shot based on one or more of the performance metrics.

28. The system of claim 17, wherein obtaining the on-device machine learning model comprises obtaining, for each particular performance metric of the one or more performance metrics, a particular metric definition comprising:
an indication of performance data related to the particular performance metric to obtain; and
logic for generating the particular performance metric.

29. The system of claim 28, wherein the particular metric definition further comprises logic for taking an action based on values of the particular performance metric.

30. The system of claim 29, wherein the logic for taking the action causes the data processing hardware to at least one of:
transmit the particular performance metric to the remote system;
revert the on-device machine learning model to a previous state;
disable the on-device machine learning model;
discontinue updates to the on-device machine learning model; or
replace the on-device machine learning model with a different on-device machine learning model.

31. The system of claim 28, wherein the particular metric definition is generated by a developer that:
generated the pre-trained machine learning model;
deployed, via the remote system the pre-trained machine learning model to the system and one or more other user devices;
receives, via the remote system, the one or more performance metrics from the system and the one or more other user devices; and
analyzes the one or more performance metrics from the system and the one or more other user devices to assess operation of the pre-trained machine learning model.

32. The system of claim 17, wherein the operations further comprise:
storing the one or more performance metrics on the system; and
transmitting the one or more performance metrics to the remote system based on at least one of a periodic schedule, a received request, a value of a particular performance metric of the one or more performance metrics, or an error condition.
